(19) United States
(12) Patent Application Publication
(10) Pub. No.: US 2017/0271874 A1
(43) Pub. Date: Sep. 21, 2017

(54) Electrical Power Recovery Apparatus

(71) Applicant: Solar-Ready Ltd, Berkshire (GB)

(72) Inventor: Raymond Luke, Berkshire (GB)

(21) Appl. No.: 15/074,398

(22) Filed: Mar. 18, 2016

(51) Int. Cl. H02J 3/38; H02J 7/00; H02J 9/06

(52) U.S. Cl. CPC H02J 3/383; H02J 3/386; H02J 9/061; H02J 7/0068

(57) ABSTRACT

An electrical power recovery apparatus comprises a switching network 6, such as a switch-mode DC to DC converter, a controller 29 arranged to operate the switching network, means to supply DC electrical power to the switching network as a power input, such as a solar power connected to terminal 25a and 25b, and output lines 10a, 10b, 10c and a return line 11 able to connect the switching network to load 3. The switching network is operable to provide at least a part of the supplied DC electrical power to the load along the output lines. The switching network is also operable to receive a ripple voltage along the return line and to combine the ripple voltage with the supplied DC electrical power as a power input, thereby harvesting the energy returned in the ripple voltage on the return line.

### FIELD OF THE INVENTION

This invention relates to an electrical power recovery apparatus and related system, in particular to an electrical power recovery and storage apparatus.

### BACKGROUND

There is a general ongoing need to reduce consumption of electrical energy both for environmental and cost reasons.

This need to reduce consumption of electrical energy is particularly urgent for devices relying on locally generated energy from small scale renewable sources, such as solar cell arrays or wind generators, either wholly or in part. One reason for this is that many small scale renewable energy sources generate a relatively low electrical power output.

Another reason is that many small scale renewable energy sources generate a fluctuating or intermittent electrical power output so that an alternative electrical power supply, such as a store of electrical energy, is required as a backup to allow continuous operation of the device. For these reasons it is generally particularly economically desirable to reduce power consumption for devices using locally generated renewable energy.

In order to reduce overall consumption of electrical energy it is desirable to reduce the consumption of electrical energy by the actual devices being used, and also to reduce the consumption of electrical energy by any supply and distribution apparatus carrying the electrical power from a renewable energy source to the devices.

### SUMMARY OF THE INVENTION

According to a first aspect the invention provides electrical energy recovery apparatus comprising: a switching network; a controller arranged to operate the switching network; means arranged to supply DC electrical power to the switching network as a power input; an output line and return line able to connect the switching network to a load; the switching network being operable to provide at least a part of the supplied DC electrical power to the load along the output line; and the switching network being operable to receive a ripple voltage along the return line and to combine the ripple voltage with the supplied DC electrical power as a power input.

Preferably an energy recovery apparatus is included with an energy recovery system is connected to

According to a second aspect of the invention there is provided an energy storage system, adapted to be housed in a storage space including at least one energy recovery apparatus. Ideally the energy recovery apparatus is shaped and dimensioned to fit into a ‘dead space’ in a house or office and to store energy and redistribute it when and to devices where energy is required.

An example of a dead space location is the base portion of a staircase. Such normally dead space modular expandable configurations that allow multiple capacity battery banks and/or power storage modules to be loaded from a front stair riser location. Ideally staircases or steps are modified to receive cassettes of batteries and/or energy recovery devices which harvest energy from sustainable sources, such as solar and/or wind generators. Another energy source is relatively cheap ‘off-peak’ energy that is typically available during evening.

Direct current (DC) power storage devices are preferably fitted in reloadable battery cartridges, into the stair voids and include DC routers and optionally alternating current (AC) supplies for ‘off-peak’ charging. Other ancillary equipment includes: uninterruptible power supplies (UPS) for providing power backup, in the event of failure and intelligent switches that are adapted to switch the supply from batteries directly to key appliances or devices, such as, for example a freezer in order to enable it continue operating and so avoid unintended thawing of food which might otherwise be wasteful.

In addition ring main synchronization is provided in addition to the aforementioned devices so that a consumer unit may be able to perform smart metering to monitor and report usage data.

The benefits of such an energy recovery system are myriad. For example there are reduced CO2 emissions and corresponding reduced energy charges.

The system may be designed to be supplied with new build homes and offices or it may be modified to be retro-fitted in established mature properties, shops and offices. Another advantage is that the system may be included in so-called ‘off-grid’ developing world carbon offsetting and similar schemes.

Preferred embodiments of the invention will now be described by way of example only and with reference to the following Figures, in which:

### DESCRIPTION OF FIGURES

FIG. 1 is a diagram of a power supply system including a power supply and recovery device according to the present invention;

FIG. 2a is a front view of a first example of a power supply and recovery device according to the present invention;

FIG. 2b is a rear view of the power supply and recovery device of FIG. 2a;

FIG. 3 is a diagram of the internal arrangement of the first example of the power supply and recovery device according to the present invention;

FIG. 4 is a diagram of the Internal arrangement of a second example of the power supply and recovery device according to the present invention;

FIG. 5 is a diagrammatical overview of a system for recovering energy and Illustrates how energy from a solar panel is modified and stored in capacitive power supply and recovery device;

FIGS. 6 and 7 show views of energy storage devices that have been incorporated into so-called ‘dead spaces’ under a staircase; and

FIG. 8 show another example of a power supply and recovery device.

### DETAILED DESCRIPTION OF THE INVENTION

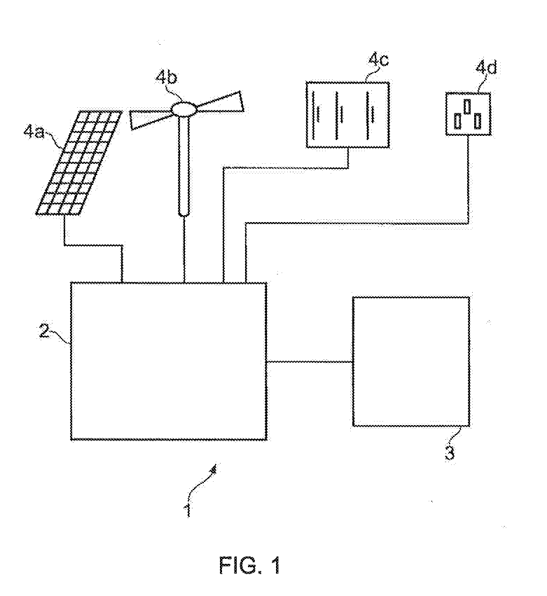

Referring to the Figures generally, apparatus according to the present invention is illustrated in FIG. 1. FIG. 1 shows the general arrangement of a power supply system 1 including a power supply and recovery device 2 according to the present invention.

The power supply and recovery device 2 provides electrical power to an electrically driven load 3, such as a personal computer (PC). The electrical power is provided to the load 3 in the form of direct current (DC) power. The power supply and recovery device 2 receives input electrical power from one or more electrical power sources 4, and converts this received electrical power to DC power at a desired voltage or voltages for supply to the load 3.

Further, in some examples the power supply and recovery device 2 may also comprise internal electrical energy storage means so that the power supply and recovery device 2 can continue to supply electrical power to the load 3 for a time, even when the power supply and recovery device 2 is receiving no, or insufficient, input electrical power from the one or more electrical power sources 4. In such examples the power supply and recovery device 2 is able to act as an uninterruptible power supply (UPS).

The electrical power sources 4 may, for example, comprise one or more of a local renewable electrical power source such as a solar cell array 4a and a local wind generator 4b, a local electrical power store such as a battery or accumulator bank 4c, and a mains AC supply 4d.

In some examples the local solar cell array may be a stand-alone outdoor solar panel converting incident sunlight into electrical power. In other examples the local solar cell array may be an array of solar cells stuck to a window pane converting incident sunlight into electrical power. In other examples the local solar cell array may be an array of solar cells located indoors, for example around the edge of a visual display screen of the PC, converting ambient light into electrical power.

The electrical power sources 4a may comprise more than one local solar cell array 4a and/or local wind generator 4b. In some examples other electrical power sources 4 may be used instead of, or in addition to those identified above.

In practice the supply of electrical power from a local renewable electrical power source, such as local solar cell arrays and wind generators, may be intermittent, and may also be provided at a variable voltage which varies significantly at different times. For example, a local solar cell array may provide power at an output voltage varying across the range 12V to 48V.

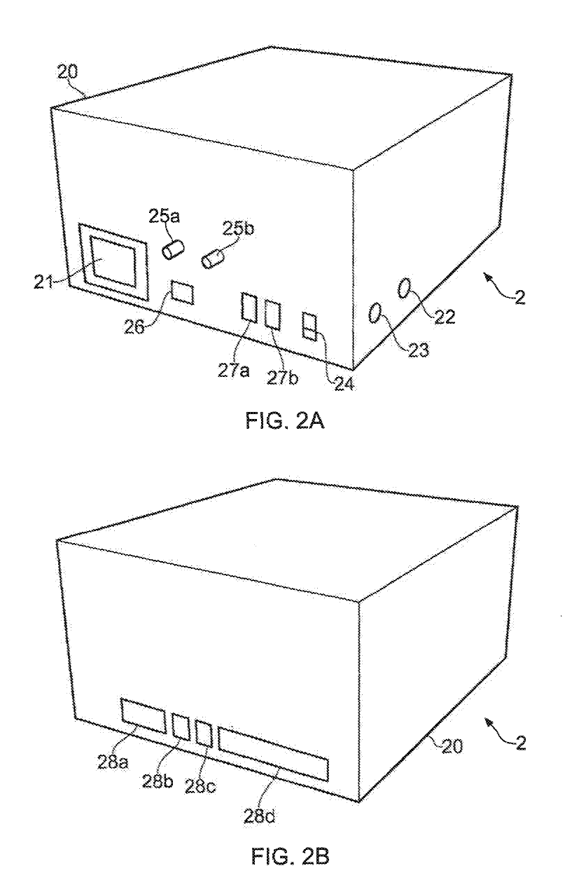

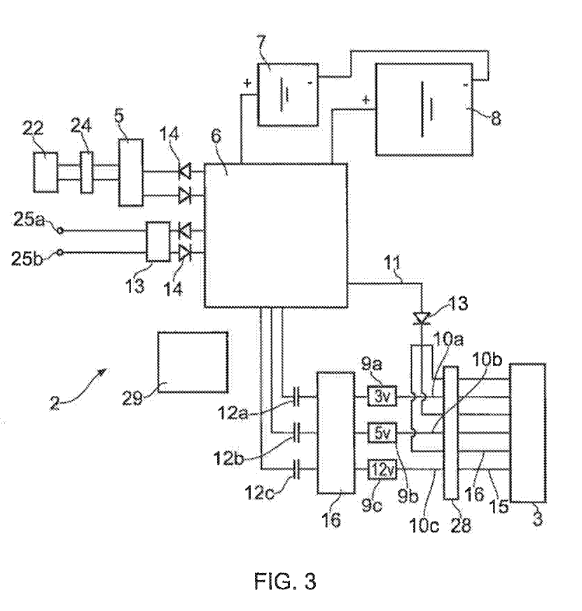

An external view of one example of the power supply and recovery device 2 is shown in FIGS. 2a and 2b, where FIG. 2a shows an isometric front view of the device 2, and FIG. 2b shows an isometric rear view.

The power supply and recovery device 2 comprises a casing 20. On a front face of the casing 20 of the device 2 a power meter display 21 is provided. The power meter display 21 displays the amount of power being supplied to the device 2 from the electrical power source or sources 4.

The front face of the power supply and recovery device 2 is provided with two different mains power input sockets 22 and 23 together with a mains power switch 24 able to switch the mains power supply through the sockets 22 and 23 on or off. The first mains power input socket 22 is arranged to receive a 240 volt AC power supply, while the second mains power input socket 23 is arranged to receive a 110 volt AC power supply. In different examples the number and physical configuration of the sockets 22 and 23 may be varied to match the standard mains power supply plugs and sockets used in the region or regions where the device 2 is intended to be used.

The mains power switch 24 is desirable for safety reasons to allow the mains power supply to the power supply and recovery device 2 to be cut off. Further, the mains power switch 24 allows a user to control whether the device 2 can draw electrical power from a mains supply by connecting or disconnecting the mains supply to the device 2. Thus, when the power supply and recovery device 2 is connected to a mains power supply and also to a local renewable electrical power source, the mains power switch 24 allows a user to control whether or not the device 2 draws power from the mains supply, which generally must be paid for, at times when the local renewable electrical power source is providing insufficient, or no, power, or whether the device 2 relies on stored power in any internal or connected electrical energy storage means when the local renewable electrical power source is providing insufficient, or no, power.

For example, if the power supply and recovery device 2 is supplied with power by an outdoor solar panel, at night time when the solar panel is generating no electrical power, a user may use the mains power switch 24 to select whether the device 2 draws power from a mains supply or relies on stored power.

The front face of the power supply and recovery device 2 is also provided with a pair of positive and negative terminals 25a and 25b for connection to local renewable electrical energy sources, such as a local solar cell array or arrays. Typically such local solar cell arrays will provide DC electrical power in the range 12 to 48 volts.

The front face of the power supply and recovery device 2 is also provided with a terminal 26 for connecting to a DC electrical line. The terminal 26 may be used as an input socket to provide an electrical power supply to the device 2, or as an output socket to allow the device 2 to supply electrical power to a load 3. The terminal 26 may operate at a DC voltage in the range 12 to 48 volts.

In some examples the terminal 26 may be used as both an input socket and an output socket at different times. In one example the terminal 26 may be used to connect the power supply and recovery device 2 to a rechargeable power supply comprising a high capacity battery bank 4c. The terminal 26 may then act as an input socket to provide power from the battery bank to the device 2 for supply to load 3 when other power supplies are not available, or are insufficient to provide the electrical power required by the load 3, and also act as an output socket to provide recharging power from the device 2 to the battery bank when surplus power over and above the electrical power required by the load 3 is available from other power supplies.

The front face of the power supply and recovery device 2 is also provided with two Ethernet sockets 27a and 27b. The Ethernet sockets 27a and 27b can act as power input or output sockets using power over Ethernet (POE) techniques. POE technology is well known, and need not be discussed in detail in this application. Generally, such a POE power input or output will be DC electrical power in the range 12 to 48 volts.

The rear face of the power supply and recovery device 2 is provided with a number of multi pin DC power output sockets 28a to 28d. The multi pin DC power output sockets 28a to 28d provide output power to a load or loads at predetermined DC voltages up to 12 volts. In the illustrated example the output power may be at 3 volts, 5 volts or 12 volts.

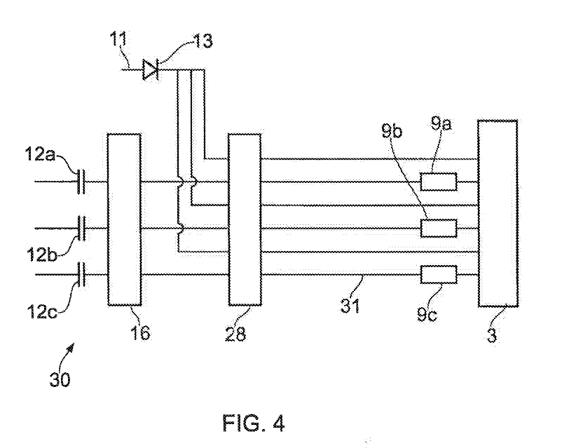

A first example of the internal arrangements of the power supply and recovery device 2 of FIG. 2 are shown schematically in FIG. 3. In the example of FIG. 3 the power supply and recovery device 2 is connected to a local solar cell array 4a as a renewable electrical power source, and is also connected to an AC mains supply as an alternative electrical power source.

The power supply and recovery device 2 comprises an inverter 5 connected to the mains power Input sockets 22 and 23 through the mains power switch 24 and adapted to convert the mains AC supply through either of sockets 22 or 23 into a 12 volt DC power supply. Suitable inverters able to operate at multiple different AC input voltages are readily available, being commonly used in battery chargers, for example.

The DC power from the inverter 5 is provided to a switching network 6 through diodes 14, which are arranged to control the direction of the current flow between the inverter 5 and the switching network 6 to prevent any backward flow of power from the switching network 6 to the inverter 5. In some examples the inverter 5 may have an integral diode or diodes for this purpose and the diodes 14 may be omitted.

The solar cell array 4a provides DC power to the power supply and recovery device 2. In practice this supplied DC power may vary in voltage over time and may be intermittent. The DC power from the solar cell array 4a is provided to the switching network 6 through an ammeter 13. Data from the ammeter 13 regarding the current flowing from the solar cell array to the device 2 may be used to derive the power value displayed by the power meter display 21.

The operation of the components of the device 2, including the switching network 6 is controlled by a controller 29. The controller 29 may comprise one or more integrated circuits. The controller 29 may be a microcontroller. The control and power connections between the controller 29 and the other components of the device 2 are not shown in the figures. The controller 29 is powered by electrical power supplied from the switching network 6.

In one example the controller 29 is supplied with the current data from the ammeter 13 and uses this to calculate the power value and supply this to the power meter display 21 for display. In some examples the power value may be calculated by a dedicated processor associated with the ammeter 13 and/or the power meter display 21.

The DC power from the solar cell array 4a is supplied to the switching network 6 through diodes 14, which are arranged to control the direction of the current flow between the solar cell array 4a and the switching network 6 to prevent any backflow of power from the power supply and recovery device 2 into the solar cell array 4a. Any such backflow of power could potentially cause damage to the solar cell array 4a. Conveniently, the diodes 14 are located between the ammeter 13 and the switching network 6, although this is not essential.

The shunt of the ammeter 13 acts as a load on the solar cell array 4a. Accordingly, so long as the solar cell array 4a is generating a significant output voltage there will be a flow of current and power around the circuit formed between the solar cell array 4a and the device 2, at least between the solar cell array 4 and the shunt of the ammeter 13, even when the device 2 is not providing any output power to a load 3, and so may not require any input power, or when the output voltage generated by the solar cell array 4a is not sufficiently high to be used by the device 2.

The switching network 6 acts as a gate array allowing multiple inputs and outputs to be interconnected in different and changeable combinations. As will be described in more detail below, the switching network 6 is arranged to be switched to connect different DC power inputs and outputs together at different times in order to control the flow of electrical power around and between the different components of the power supply and recovery device 2.

In the illustrated example the switching network 6 comprises a switch-mode DC to DC converter. Accordingly, the switching network 6 is able to change the voltage and polarity of DC electrical power passing through the switching network 6, in addition to connecting different DC power inputs and outputs together. In other examples the switching network may comprise a bridge rectifier array.

In the illustrated example the operation of the switching network 6 is controlled by electronic control logic circuitry comprised in the controller 29. In some examples the control logic circuitry may be integrated with the switching network 6 in a single integrated circuit. In some examples the control logic circuitry may be provided by a separate controller, such as a microcontroller.

The power supply and recovery device 2 further comprises a first battery 7 and a second battery 8. The first and second batteries 7 and 8 are batteries of the same type having the same nominal voltage, but having different charge storage capacities, with the second battery 8 having a larger charge storage capacity than the first battery 7. As a result, the second battery 8 will have a larger capacitance than the first battery.

Preferably, the capacity of the second battery 8 is about 3 to 4 times the capacity of the first battery 7. In some examples the capacity of the second battery 8 is about 3.5 times the capacity of the first battery 7. In one example the first and second batteries are both lead-acid accumulators with a nominal 12 volt output voltage, the first battery 7 having a capacity of 2 Amp hours and the second battery 8 having a capacity of 7.2 Amp hours.

The first battery 7 is connected to the switching network 6 so that positive voltages from the switching network 6 can be applied to the positive terminal of the first battery 7. The negative terminal of the first battery 7 is left floating, and is not connected to the switching network 6. As a result the first battery 7 acts as a capacitor from the point of view of the applied voltages.

The second battery 8 is also connected to the switching network 6 so that positive voltages from the switching network 6 can be applied to the positive terminal of the second battery 8. The negative terminal of the second battery 8 is left floating, and is not connected to the switching network 6. As a result the second battery 8 also acts as a capacitor from the point of view of the applied voltages.

The power supply and recovery device 2 further comprises a number of output voltage regulators 9 which each supply electrical power to a load 3 at a specific positive voltage along a corresponding output line 10. Each output line 10 is connected to a respective positive voltage output pin of one of the multi pin DC power output sockets 28, and through these to the load 3 along suitable positive supply lines 15. In the illustrated example three output voltage regulators 9 of the power supply and recovery device 2 are shown. A first output voltage regulator 9a supplying electrical power at a voltage of 3 volts along a corresponding first output line 10a, a second output voltage regulator 9b supplying electrical power at a voltage of 5 volts along a corresponding second output line 10b, and a third output voltage regulator 9c supplying electrical power at a voltage of 12 volts along a corresponding third output line 10c. The output lines 10a to 10c are connected through respective positive pins of the multi pin DC power output sockets 28 to the load 3 to provide the load 3 with power at the respective DC voltages through suitable positive supply lines 15.

A common neutral return line 11 connects the switching network 6 to negative neutral pins of the multi pin DC power output sockets 28 through a diode 13, and is connected through these neutral pins to the load 3 through suitable negative return lines 16. Accordingly, the load can be provided with DC electrical power at the desired voltages through circuits formed by the first to third positive voltage output lines 10a to 10c and the common neutral return line 11, through the positive and neutral pins of the multi pin DC power output sockets 28 and suitable positive supply lines 15 and negative return lines 16. In some examples the positive supply lines 15 and negative return lines 16 may be combined in suitable cables.

The diode 13 controls the direction of the current flow around the circuits between the power supply and recovery device 2 and the load 3, so that the current only flows in a forward direction from the voltage regulators 9 through the positive output pins and back through the neutral pins to the neutral return line 11, and is prevented from flowing in a backward direction from the neutral return line 11 to the voltage regulators 9. Thus, any possible backflow of power and current from the power supply and recovery device 2 to the load 3 in the wrong direction as a result of the common neutral return line 11 becoming more positive than a voltage output line 10 is prevented. Any such backflow of power could potentially cause damage to the load 3.

Each of the first to third output voltage regulators 9a to 9c is connected to a respective supply capacitor 12a to 12c through an output voltage timing unit 16. The output voltage timing unit 16 is controlled by the controller 29. The supply capacitors 12 are connected to the switching network 6 and can be charged to a desired voltage by the switching network 6. The switching network 6 operates to charge each of the supply capacitors 12a to 12c to approximately the desired voltage to be output along the corresponding output line 10 through the corresponding voltage regulator 9.

In operation of the power supply and recovery device 2, DC electrical power at a variable voltage is supplied to the device 2 from the solar cell array 4a. As explained above, this electrical power is provided to the switching network 6. Other electrical power may also be supplied to the switching network 6, as will be explained in more detail below.

The switching network 6 divides the received power into a number of different electrical power streams of pulse modulated DC power. A first output power stream is output from the switching network 6 and supplied to the positive terminal of the first battery 7, which acts as a capacitor as explained above. In this arrangement the first battery 7 is only able to absorb a small part of the supplied electrical power, and the unabsorbed part of the supplied electrical power of the first power stream is returned to the switching network 6.

The unabsorbed part of the first power stream is divided by the switching network 6 and output from the switching network 6 as second and third pulse modulated output power streams. The second output power stream is supplied to the positive terminal of the second battery 8, which acts as a capacitor as explained above. The second output power stream is pulse modulated DC power. That is, the second output power stream is made up of a series of discrete DC voltage pulses. In this arrangement the second battery 8 is only able to absorb a small part of the supplied electrical power, and the unabsorbed part of the supplied electrical power of the second power stream is returned to the switching network 6.

As explained above, each of the first and second batteries 7 and 8 will act as a capacitor. An electric circuit comprising a resistance and a capacitance will have a time constant, the time constant τ in seconds being related to the resistance R in ohms and the capacitance C in farads by the equation: τ=RC.

Accordingly, the circuits formed by the first battery 7 and the second battery 8 will each have a time constant because in addition to the capacitance of the first or second battery 7 or 8 acting as a capacitor the circuit will also have a resistance. Even if there are no discrete resistors associated with the circuits linking the first and second batteries 7 and 8 to the switching network 6 there will inevitably be resistances associated with each circuit as a result of the internal resistances of the first and second batteries 7 and 8 and the resistances of the electrical connectors forming the circuits. In the illustrated example the capacitances and resistances of the circuits linking the first and second batteries 7 and 8 to the switching network 6 are arranged so that the time constants of the two circuits are the same. In practice this may conveniently be arranged by determining the capacitance and internal resistance of each of the first and second batteries 7 and 8, and adjusting the length of the electrical connectors forming one or both circuits to make the time constants of the two circuits the same.

In practice the capacitances of the first and second batteries, and thus the time constant of the circuits, will vary depending upon the degree of charge of the batteries. In general, the circuits should be arranged to have the same time constant when both batteries are fully charged.

As explained above the second power stream supplied to the second battery 8 is pulse modulated DC power. The pulse modulation of the second power stream is arranged by the switching network 6 under the control of the controller 29 to be modulated at a frequency corresponding to the time constant of the circuit connecting the switching network 6 and the second battery 8. As explained above, this time constant will vary with the level of charge of the second battery 8. Accordingly, the controller 29 may vary the modulation frequency based on the level of charge of the second battery 8.

A third output power stream is output from the switching network 6 and supplied to the supply capacitors 12. In examples where there are multiple supply capacitors 12 to be charged to different voltages to supply power to voltage regulators 9 to generate different voltage outputs, the third power stream is subdivided into multiple separate power streams which are supplied to respective ones of the supply capacitors 12. In the illustrated example the switching network 6 outputs three third power streams, which are each output to a respective one of the supply capacitors 12 to charge the respective supply capacitor 12 to approximately the desired output voltage of the corresponding output line 10.

As explained above the first and second batteries 7 and 8 have different capacitances, with the second battery 8 having a larger capacitance than the first battery 7. As a result of the difference between the capacitances of the first and second batteries 7 and 8 there is a tendency for power and charge to flow from the smaller capacitance first battery 7 to the larger capacitance second battery 8. This phenomenon tends to generate an energy flow between the two batteries 7 and 8, from the first battery 7 to the second battery 8 through the switching network 6. Further, the supply capacitors 12 have different capacitances from the first and second batteries 7 and 8, with the supply capacitors 12 having smaller capacitances than the first and second batteries. As a result of the difference between the capacitances of the supply capacitors 12 and the first and second batteries 7 and 8 there is a tendency for power and charge to flow from the smaller capacitance supply capacitors 12 to the (relatively) larger capacitance first battery 7. This phenomenon tends to generate an energy flow between the supply capacitors 12 and the first battery 7 through the switching network 6.

In the illustrated example the respective circuits connecting each of the supply capacitors 12 to the switching network 6 are arranged to have the same time constant as the circuits linking the first and second batteries 7 and 8 to the switching network 6. In some alternative examples this may not be done. However, this may allow the efficiency of the device 2 to be improved.

In the illustrated example each of the supply capacitors 12a to 12c has the same capacitance. This is not essential. However, this may simplify design of the device 2.

Accordingly, there is a tendency for power to flow from the supply capacitors 12 to the first battery 7 and then to the second battery 8. This power flow tends to takes place at a frequency corresponding to the time constant of the circuits connecting the first and second batteries 7 and 8 and the supply capacitors 12 to the switching network 6. The tendency for this power flow to take place is increased by the second power stream to the second battery 8 being pulse modulated at this frequency.

The switching network 6 is operated under the control of the controller 29 to allow this power flow to occur. As a result, this tendency for power to flow from the supply capacitors 12 to the first battery 7 and then to the second battery 8 in combination with the supplying of the second and third output power streams to the second battery 8 and the supply capacitors 12 will produce a circulation of energy between the first and second batteries 7 and 8 and the supply capacitors 12 through the switching network 6.

As is explained above, in operation of the power supply and recovery device 2 each of the supply capacitors 12a to 12c is supplied with pulse modulated DC power by the switching network 6 to charge the respective supply capacitors 12a to 12c to their respective desired voltages.

When the load 3 requires power at a specific voltage at a particular time, the controller 29 operates the output voltage timing unit 16 to supply power at the required voltage from the appropriate one of the supply capacitors 12a to 12c through the respective voltage regulator 9a to 9c at the time that the power at that voltage is required and for the necessary length of time. The output voltage timing unit 16 sends the power from the supply capacitor 12 to the respective voltage regulator 9 as a series of DC pulses. The voltage regulator 9 then transforms this series of pulses into power at the desired constant DC voltage for supply to the load 3 for the desired length of time.

When the load 3 is not being supplied with electrical power from one of the voltage regulators 9 the corresponding supply capacitor 12 will be charged up to the voltage of the pulse modulated DC power supplied to the capacitor 12 by the switching network 6. The capacitor 12 will then stop absorbing electrical power from the switching network 6 because the voltage of the capacitor 12 and the supplied pulses will be the same.

This approach of intelligent power management where the power at a desired DC voltage is supplied to the load only at times when the voltage is actually required can significantly reduce the amount of electrical power consumed in order to operate the load 3.

Many electrical loads, such as PC's, comprise components which only require power to be provided at specific voltages at certain times when the component is actually using the power to carry out a required action. At other times no power is actually consumed by the component so that power used to maintain the DC line voltage to the component is wasted. Some such components operate intermittently. One example of a component which operates intermittently is a cooling fan, which only needs to be operated when temperatures exceed a predetermined threshold.

Accordingly, power can be saved by only providing power to the fan when the temperature threshold is exceeded and the fan is required to be operated. Some such components operate continuously but only require power during certain parts of their operation. Examples of components which operate continuously but only require power during certain parts of their operation are a processor or solid state memory of a PC. Although these operate continuously they only require power at certain stages of their operating cycles. Accordingly, by synchronizing the power supply with a system clock controlling the processor or solid state memory and only supplying power to at necessary times of the operating cycle, power can be saved. For example, a PC CPU processor having a rated power requirement of 96 watts may only consume only as little as 22 watts when operated in this manner.

Further, many electrical loads, such as PCs comprise components which operate continuously, but do not actually require a continuous supply of power, or power at specific times to operate. One example of a component which operates continuously but does not require power continuously or at specific times is a hard drive. Provided that a hard drive is provided with sufficient power over time to keep it rotating it is not necessary that the power is supplied continuously, and the precise timing at which the power is supplied is not critical. Accordingly, power can be supplied periodically to a hard drive as power becomes available, for example when power is not required by other components of the PC, and not at other times, provided that a required amount of power is provided over a specified time, allowing power to be saved.

When power is supplied to the load 3 some of the supplied power will be wasted and transformed into unwanted ripple voltages on the neutral return lines from the load. Such ripple voltages may, for example, be generated by the switching on and off of components of the load 3, or by changes in the amount of power consumed by components of the load 3.

These ripple voltages will return along the neutral return lines to the device 2, through the diode 13 and along the common neutral return line 11 to the switching network 6. The switching network 6 takes these ripple voltages and combines them with the other power inputs to the switching network 6 to generate the desired power output streams from the switching network 6. This allows the electrical energy contained in the ripple voltages to be recovered and re-used. If this was not done the electrical energy contained in the ripple voltages would simply be converted into heat and dissipated.

By harvesting the energy returned in the ripple voltages on the neutral return lines the amount of power required by the power supply and recovery device 2 in order to provide a specified amount of power to a load 3 may be reduced, or to put this another way, the overall efficiency with which power supplied to the device 2 can be converted to power consumed by the load 3 can be increased.

In the illustrated example, in addition to the switching network 6 comprising a switch-mode DC to DC converter, the switching network also comprises a plurality of Zener diodes and switches arranged to allow power input to the switching network at voltages equal to or above the desired charging voltages of the different ones of the supply capacitors 12 to be selectively supplied to the individual supply capacitors 12 without passing through the switch-mode DC to DC converter. This may allow the efficiency of the device 2 to be further increased. Passing electrical power through a switch-mode DC to DC converter results in inevitable power losses. When DC electrical power is available as an input to the switching network 6 at voltages equal to or above that voltage of the supply capacitors 12 these losses can be avoided by routing the power to the capacitors 12 without passing through the switch-mode DC to DC converter. Where the voltage of the DC Input power must be increased or changed in polarity in order to charge the supply capacitors 12 the switch mode DC to DC converter must be used and the resulting losses must be tolerated.

In some examples the switching network may not include these additional diodes and switches, in order to simplify the device.

When the DC electrical power supply from the solar cell array 4a is insufficient to fully power the power supply and recovery device 2, for example when the solar cell array 4a is producing no electrical power, the device 2 may either use power stored in the first and second batteries 7 and 8 to provide power to the load 3, or use power from the mains AC supply through the inverter 5 to provide power to the load 3.

This decision may be made by a user manually switching the mains power switch 24 off. Clearly, when the mains power switch 24 is off the device 2 cannot use power from the mains AC supply. When the mains power switch 24 is on the controller 29 can decide whether to use power from the mains AC supply or not. If power from the mains AC supply is not used, or is not available, the device must use power stored in the first and second batteries 7 and 8. The decision whether to use mains power can be made depending on the relative importance of minimizing expense and maintaining an uninterrupted supply of power to the load 3.

In general, if it is more important to minimize cost the power stored in the first and second batteries 7 and 8 should be used first, and only when this has been consumed should the mains AC supply be used. However, this has the disadvantage that if the mains AC power supply fails when the batteries 7 and 8 are empty, or near empty, it may not be possible for the device to continue supplying power to the load 3.

If it is more important to maintain an uninterrupted flow of power to the load 3 the AC mains supply should be used first, and the power stored in the batteries 7 and 8 reserved for use when the AC mains supply fails. However, this has the disadvantage that more power than necessary may be used from the AC mains supply, unnecessarily incurring costs. In some examples, when the DC electrical power supply from the solar cell array 4a is insufficient to fully power the power supply and recovery device 2, the device 2 may first use power from the batteries 7 and 8, and then switch to using the AC mains supply when the amount of power stored in the batteries 7 and 8 drops to a predetermined level, so that a reserve amount of power is still available from the batteries 7 and 8 as a precaution against failure of the AC mains supply.

When the power supply and recovery device 2 is using the mains AC power supply it operates in essentially the same way as described above. The fact that the input DC power supply provided to the switching network 6 comes from the inverter 5 rather than the local solar cell array 4a does not require any change to the described operation of the device 2.

When no input power is available to the power supply and recovery device 2 the supply capacitors are provided with DC electrical power drawn from the first and second batteries 7 and 8, allowing the device 2 to act as an uninterruptible power supply and maintain the supply of electrical power to the load 3. This continues until the batteries 7 and 8 are discharged to the point where their voltage is insufficient to provide the required output power and voltage along the output lines 10.

When the power supply and recovery device 2 is using power from the batteries 7 and 8 the harvesting of energy from ripple voltages on the neutral return line is continued in order to maximize efficiency.

In examples where, in addition to the switching network 6 comprising a switch-mode DC to DC converter, the switching network also comprises a plurality of Zener diodes and switches arranged to allow power input to the switching network at voltages equal to or above the desired charging voltages of the different ones of the supply capacitors 12 to be selectively supplied to the individual supply capacitors 12 without passing through the switch-mode DC to DC converter, these Zener diodes and switches may be used to supply electrical power from the batteries 7 and 8 to the capacitors 12 without passing through the switch-mode DC to DC converter. This may allow the efficiency of the device 2 to be further increased.

When the first and second batteries 7 and 8 are not fully charged and the power supply and recovery device 2 is supplied with electrical power from an electrical power source 4 the first and second batteries will absorb more power from the first and second power stream respectively until the batteries 7 and 8 are fully charged. Even in this situation the first and second batteries 7 and 8 will only be able to absorb a small part of the supplied electrical power. Typically, the batteries 7 and 8 will only be able to absorb between 10% and 20% of the applied power.

The above description relates to an example where the device 2 is supplied with DC power by a local solar cell array 4a. The operation of the device 2 will be essentially the same if other DC power sources are used additionally or as alternatives, for example a wind generator 4b. If a battery bank 4c is used with the device 2, the operation of the device 2 will be essentially the same when the device 2 is drawing DC power from the battery bank 4c. If the device 2 is responsible for recharging the battery bank 4c, the battery bank 4c will be one of the loads supplied with power by the device 2. In this case the controller 29 of the device 2 will be arranged to provide power to re-charge the battery bank 4c only when suitable power is available from another electrical power source. There would be no purpose in using power from the batteries 7 and 8 to recharge the battery bank 4c.

In the illustrated example the electrically driven device 3 is a PC. In other examples different devices may be used.

In the illustrated example the power meter displays the amount of power being supplied to the device 2. In some examples the power meter display may be arranged to display other information, such as the amount of power being supplied to a load or loads 3 by the device 2. In some examples the power meter display 21 may be arranged to operate in a number of different user selectable modes displaying different information.

In the illustrated example of FIGS. 2a and 2b the power supply and recovery device 2 is a stand-alone device separate from the load or loads 3. In other examples the device 2 may be integral with a load or loads 3. For example, where the loads 3 are electrical power consuming components of a PC the device 2 may be integral with the PC.

In the illustrated example of FIG. 3 the voltage regulators 9 are a part of the power supply and recovery device 2 and supply DC power to the load 3. This arrangement is preferably used where the device 2 is relatively close to, or integral with, the load 3.

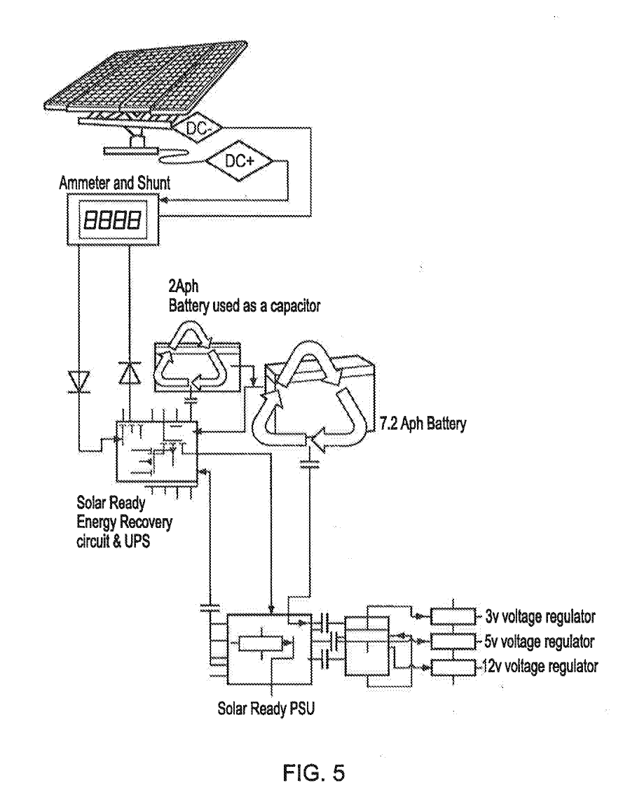

A second example of a power supply and recovery device 30 is shown in part in FIG. 4. FIG. 4 shows the arrangement of an output section of the device 30, other parts of the device 30 are the same as the device 2 of the first example shown in FIG. 3.

The second example of FIG. 4 may be used when the load 3 is at a significant distance from the power supply and recovery device 30. In the second example the supply capacitors 12 and the output voltage timing unit 16 are arranged as in the device 2. However, the voltage regulators 9 are not part of the device 2, but are instead located close to the load 3 and remotely from the device 2. The voltage regulators 9 are connected to the output voltage timing unit 16 by respective output lines 31.

As explained above the output voltage timing unit 16 sends power from the supply capacitors 12 to the respective voltage regulators 9 as series of DC pulses. Such series of DC pulses act as a pseudo AC signal, and as a result they may suffer less from loss of power over distance as they travel along the output lines 31 to the voltage regulators 9 than would be the case for a corresponding DC signal. Accordingly, the second example may be more efficient at supplying power to a remote load than the first example.

In some examples, in addition to the external electrical power sources 4 described above the power supply and recovery device 2 may also be provided with electrical power recovered from waste heat produced by the device 2 or the load 3. In some examples this heat recovery may be carried out using Peltier effect devices extending between parts of the device 2 and/or load 3 which generate heat in operation and cooler heat sinks, such as air cooled fins, and using the Peltier effect to generate DC power. This heat generated DC power can then be supplied to the switching network 6 for distribution and use in the same way as other available DC power.

In some examples where the switching network 6 is a switch-mode DC to DC converter, the switch-mode DC to DC converter may be capacitor based, rather than inductance based. This may reduce power losses in the DC to DC converter.

The description above describes different examples. All of the examples are closely related and alternatives, explanations and advantages disclosed in relation to one of the examples can generally be applied in an analogous manner to the other examples. In particular, elements of one example may be used in the other examples, and analogous elements can be exchanged between the examples.

The above description uses relative location terms such as front and rear. These are used for clarity to refer to the relative locations of the referenced parts in the illustrated figures, and should not be regarded as limiting regarding the orientation and/or location of parts of embodiments of the invention during manufacture or in use.

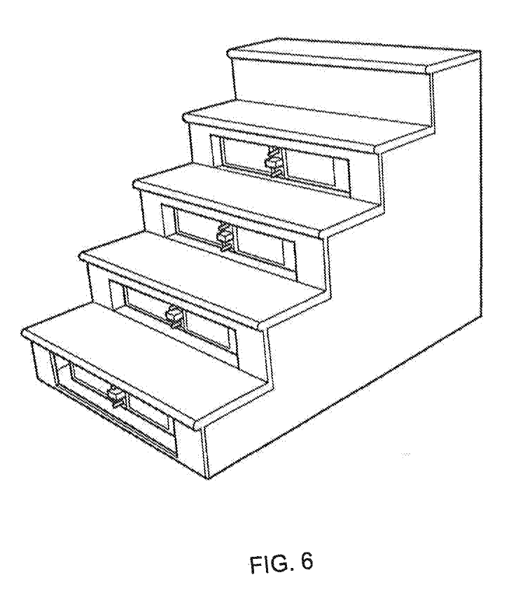

Referring now to FIG. 5, there is shown a diagrammatical overview of a system for recovering energy. The system converts DC current from a solar panel or array of photocells, typically from anywhere between 8-48 Volts and passes this into a 2A per hour capacitor. The capacitor stores charge and transmits any surplus current to the energy recovery unit as described above. A series of pulses are transmitted to another larger capacity battery (typically at 7.2 A per hour), so allowing the circuit to shunt energy via the energy recovery circuit. High and low voltages are drawn to discharge capacitors, in voltage regulating devices, which have a constant load on them from output devices. The system provides a constant energy of between 5 and 500 W and energy is recovered/topped up from wind generators and/or Peltier heat recovery devices and/or solar panels. FIG. 5 therefore illustrates how energy from a solar panel is modified and stored in capacitive power supply and recovery device for prolonged use well after ambient light levels have dropped below the generation threshold.

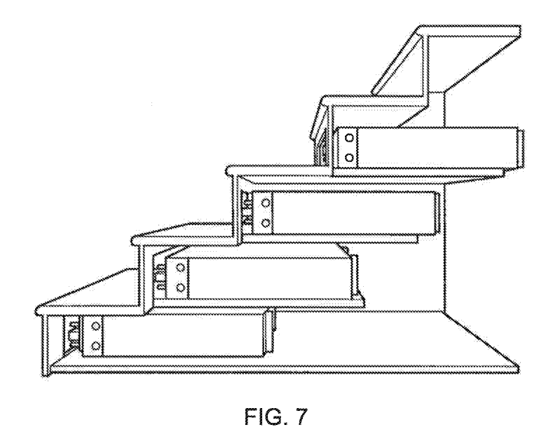

FIGS. 6 and 7 show views of energy storage devices that have been incorporated into so-called ‘dead spaces’ under a staircase.

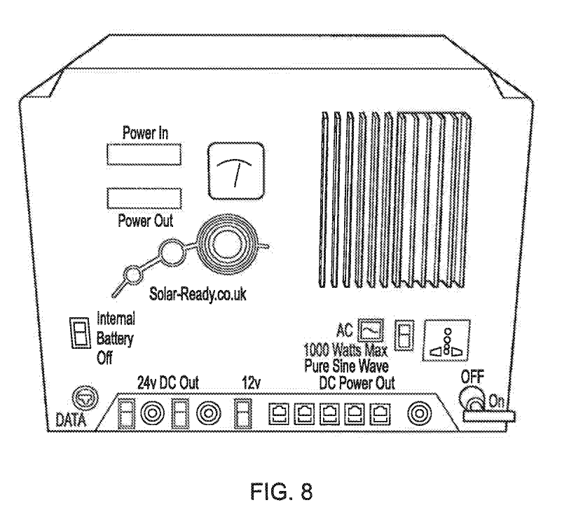

FIG. 8 shows another example of a power supply and recovery device of the type supplied by solar-ready limited.

The apparatus described above may be implemented at least in part in software. Those skilled in the art will appreciate that the apparatus described above may be implemented using general purpose computer equipment or using bespoke equipment. The hardware elements, operating systems and programming languages of such computers are conventional in nature, and it is presumed that those skilled in the art are adequately familiar therewith.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment.

It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Those skilled in the art will recognize that the invention has a broad range of applications, and that the embodiments may take a wide range of modifications without departing from the inventive concept as defined in the appended claims.

1. An electrical energy power recovery apparatus comprising: switching network; a controller arranged to operate the switching network; means arranged to supply DC electrical power to the switching network as a power input; an output line and return line able to connect the switching network to a load; the switching network being operable to provide at least a part of the supplied DC electrical power to the load along the output line; and the switching network being operable to receive a ripple voltage along the return line and to combine the ripple voltage with the supplied DC electrical power as a power input.

2. The apparatus according to claim 1, wherein the switching network comprises a switch-mode DC to DC converter.

3. The apparatus according to claim 1, wherein the output line is a positive output line and the return line is a neutral return line.

4. The apparatus according to claim 3, wherein an energy supply provides an input current, the energy source being from the group comprising: a solar panel, a Peltier current source and a wind generator.

5. The apparatus to claim 1, wherein the apparatus comprises a plurality of output lines and one or more corresponding plurality of return lines.

6. The apparatus according to claim 5, wherein all of the return lines are connected to the switching network through a common return line.

7. The apparatus according to claim 1, wherein the, or each, return line is connected to the switching network through at least one diode.

8. The apparatus according to claim 7, wherein the, or each, diode is located on the common return line.

9. The apparatus according to claim 1, and further comprising: a first battery having positive and negative terminals and being connected to the switching network through a positive terminal of the first battery; and a second battery having positive and negative terminals and being connected to the switching network through a positive terminal of the second battery; wherein the negative terminals of the first and second batteries are not connected to the switching network; and the second battery has a greater power storage capacity than the first battery.

10. The apparatus according to claim 9, wherein the second battery has a power storage capacity between 3 and 4 times greater than the first battery.

11. The apparatus according to claim 10, wherein the second battery has a power storage capacity of 7.6 Amp hours and the first battery has a power storage capacity of 2 Amp hours.

12. The apparatus according to claim 11, wherein the first and second batteries are lead-acid batteries.

13. The apparatus according to claim 12, wherein the first and second batteries are lead-acid batteries.

14. The apparatus according to claim 9, wherein: the first battery is connected to the switching network to form an LC circuit having a natural frequency; and the second battery is connected to the switching network to form an LC circuit having the same natural frequency.

15. The apparatus according to claim 9, wherein the switching network is arranged to provide a least a part of the supplied DC electrical power to the first battery and to provide at least part of the supplied DC electrical power to the second battery.

16. The apparatus according to claim 15, wherein the switching network is arranged to provide pulse modulated DC electrical power to the second battery.

17. The apparatus according to claim 16, in which the switching network is arranged to provide pulse modulated DC electrical power to the second battery modulated at said natural frequency.

18. The apparatus according to claim 9, wherein the switching network is arranged to provide at least a first part of the supplied direct current supply to the first battery; to receive from the first battery a portion of the first part of the supplied DC electrical power that is not absorbed by the first battery; and then to provide a second part of the supplied DC power to the second battery, the second part of the supplied DC power being derived from said received portion.

19. The apparatus according to claim 18 is adapted to fit into an understair space.

20. An electrical energy harvesting system including the apparatus according to claim 19, further includes a power generator an uninterruptible power supply and an intelligent switch arranged to switch the supply preselected appliances in the event of power failure.

21-22. (canceled)
